(19) United States
(12) Patent Application Publication
(10) Pub. No.: US 2026/0126808 A1
(43) Pub. Date: May 7, 2026

(54) METHOD FOR EXTRICATING POOL CLEANING ROBOT FROM STUCK STATE AND THE CORRESPONDING POOL CLEANING ROBOT

(71) Applicant: Shenzhen Aiper Intelligent Co., Ltd., Shenzhen (CN)

(72) Inventors: Kai Zheng, Shenzhen (CN); Gujie Tang, Shenzhen (CN)

(21) Appl. No.: 19/022,178

(22) Filed: Jan. 15, 2025

(30) Foreign Application Priority Data
Nov. 5, 2024 (CN) 2024115653381

(51) Int. Cl. G05D 1/639; E04H 4/16; G05D 1/467; G05D 105/10; G05D 107/00; G05D 109/30

(52) U.S. Cl. CPC G05D 1/639; E04H 4/1654; G05D 1/467; G05D 2105/10; G05D 2107/29; G05D 2109/38

(57) ABSTRACT

Disclosed are a method for extricating a pool cleaning robot from a stuck state and a pool cleaning robot. The method includes: controlling the pool cleaning robot to travel in a pool to perform a cleaning operation; acquiring an operating parameter of the pool cleaning robot during the traveling, and determining whether the pool cleaning robot is stuck due to being suspended according to the operating parameter; if it is determined that the pool cleaning robot is stuck due to being suspended, performing an extrication action; as example, the extrication action includes adjusting a magnitude and/or direction of the driving force of the pool cleaning robot. It can be detected the situation in which the pool cleaning robot is stuck due to being suspended, thus improving the ability of the extrication.

### CROSS-REFERENCE

This application claims the priority of China Patent Application No.2024115653381 filed on Nov. 5, 2024, the disclosure of which is considered as a part of the disclosure of this application and is hereby incorporated by reference.

### TECHNICAL FIELD

The present disclosure relates to the technical field of a pool cleaning robot, in particular to a method for extricating a pool cleaning robot from a stuck state and the corresponding pool cleaning robot.

### BACKGROUND

In recent years, with the progress of science and technology and the development of Internet, robot technology has become increasingly mature and been widely used in various fields of life. On the market, a large number of robots with various special purposes have emerged, among which swimming pool cleaning robots can do a lot of cleaning work for users and provide significant help. The pool cleaning robots can be used to clean the bottom and side walls of the swimming pool, such as removing the silt, dirt and algae, to keep the swimming pool clean.

### SUMMARY

The disclosure provides a method for extricating a pool cleaning robot from a stuck state and the corresponding pool cleaning robot; based on the method, it can be detected that the pool cleaning robot is stuck due to being suspended and the corresponding ability to extricate the pool cleaning robot from a stuck state can be improved.

In a first aspect, the present disclosure provides a method for extricating a pool cleaning robot from a stuck state, which comprises:
controlling the pool cleaning robot to travel in the pool to perform a cleaning operation;
acquiring an operating parameter of the pool cleaning robot during the traveling process, and determining whether the pool cleaning robot is in a stuck state due to being suspended according to the operating parameter;
if it is determined the pool cleaning robot is stuck due to being suspended, performing an extrication action;
wherein, the extrication action comprises adjusting a magnitude and/or direction of a driving force of the pool cleaning robot.

In a second aspect, the present disclosure also provides a pool cleaning robot including:
a traveling mechanism configured to driving the pool cleaning robot to travel on a bottom or sidewall of the pool;
a water spraying mechanism configured to provide water thrust for the pool cleaning robot; and
a control mechanism configured to acquire an operating parameter of the pool cleaning robot in the traveling process, to determine whether the pool cleaning robot is in a stuck state due to being suspended according to the operating parameter, and control the pool cleaning robot to perform an extrication action if it is determined the pool cleaning robot is in a stuck state due to being suspended, wherein the extrication action includes at least one of adjusting a magnitude of the driving force of the pool cleaning robot; or adjusting a direction of the driving force of the pool cleaning robot.

According to the embodiments of the present disclosure, it can be detected whether the pool cleaning robot is in a stuck state due to being suspended by acquiring the operating parameter of the pool cleaning robot during the travel, and if it is detected that the pool cleaning robot is in the stuck state due to being suspended, the pool cleaning robot can be extricated from the stuck state by adjusting the driving force of the pool cleaning robot. Since the operating parameter of the pool cleaning robot during the normal travel is significantly different from that in the stuck state and the operating parameter can more accurately reflect whether the pool cleaning robot is stuck, the embodiments of the present disclosure can efficiently detect the stuck state due to being suspended by detecting the operating parameter, thus improving the corresponding ability of the pool cleaning robot to get out of the stuck state.

### BRIEF DESCRIPTION OF THE DRAWINGS

FIGS. 1A-1B schematically illustrate an appearance of a pool cleaning robot according to the present disclosure.

FIG. 2 is a flow chart for illustrating a method for extricating a pool cleaning robot from a stuck state according to an embodiment of the present disclosure;

FIG. 3 is a flow chart for illustrating a method for extricating a pool cleaning robot from a stuck state according to an embodiment of the present disclosure;

FIG. 4 is a schematic structural diagram of a pool cleaning robot according to an embodiment of the present disclosure.

### DETAILED DESCRIPTION

The present disclosure will be further described in detail with the accompanying drawings and examples. It can be understood that the specific embodiments described herein are only used to explain the disclosure, and are not limited to the disclosure. In addition, it should be noted that, for the convenience of description, only some parts related to the present disclosure, but not all structures, are illustrated in the drawings.

Before discussing the exemplary embodiments in more detail, it should be noted that some exemplary embodiments are described as processes or methods depicted as flowcharts. Although the flowchart describes each step as a sequential process, many of the steps can be implemented in parallel, concurrently or simultaneously. In addition, the order of the steps can be rearranged. The process may be terminated when its operation is completed, but there may be additional steps not included in the drawings. A process may correspond to a method, a function, a procedure, a subroutine, a sub-computer program, and the like.

In addition, the terms “first”, “second” and the like can be used herein to describe various directions, actions, steps or elements, but these directions, actions, steps or elements are not limited by these terms. These terms are only used to distinguish one direction, action, step or element from another. For example, without departing from the scope of this application, the first information may be referred to as the second information, and similarly, the second information may be referred to as the first information. Both the first information and the second information are information, but they might not be the same information. The terms “first”, “second” and so on cannot be understood as indicating or implying relative importance or implicitly indicating the number of indicated technical features. Therefore, the features defined as “first” and “second” may include one or more of these features explicitly or implicitly. In the description of this disclosure, “plural” means at least two, such as two, three, etc., unless otherwise specifically defined.

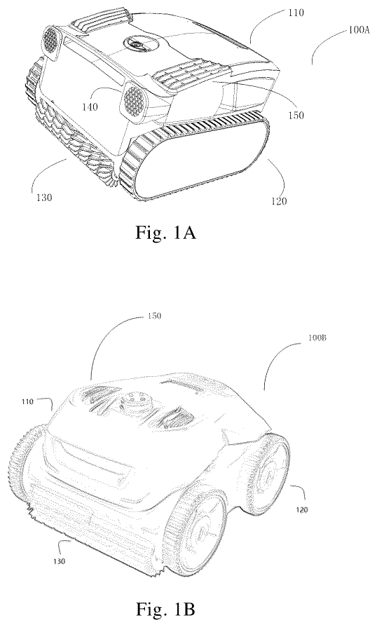

FIG. 1A schematically illustrates an appearance of a pool cleaning robot 100A according to an embodiment of the present disclosure. The pool cleaning robot 100A can clean the bottom, sidewalls, water therein and water surface of the pool (such as a swimming pool) as needed, for example, to clean the garbage in the water, on the bottom and the water surface, and clean the dirt on the bottom and walls of the pool. As illustrated in FIG. 1A, the pool cleaning robot 100 may include a housing 110, a traveling mechanism 120, a cleaning unit 130 and other structures/components. As an example, the pool cleaning robot 100 may further include a buoyancy adjusting unit (not illustrated), so that the pool cleaning robot can adjust its depth in the water as needed, for example, it can float on the water surface, dive into the water, and sink to the bottom of the water, so as to carry out the cleaning operation on the water surface, in the water or at the bottom of the water. As an example, a control bin, a power bin and a filter bin (not illustrated) can be arranged in the housing 100, wherein control circuits such as a microprocessor, a digital signal processor (DSP) and a microcontroller can be arranged in the control bin, a driving mechanism such as a water pump and a driving motor can be arranged in the power bin, and a filter unit can be arranged in the filter bin so as to filter and purify the water entering the filter bin through a water inlet, filter out impurities therein, and discharge the filtered water to the outside of the pool cleaning robot. As an example, the traveling mechanism 120 of the pool cleaning robot 100A illustrated in FIG. 1A is a crawler traveling mechanism, while the traveling mechanism 120 of the pool cleaning robot 100B illustrated in FIG. 1B is a wheeled traveling mechanism.

As an example, FIG. 1A also illustrates drainage outlets 140 symmetrically arranged on the rear side of the housing 110 of the pool cleaning robot 100 with respect to the longitudinal axis of the body of the pool cleaning robot, drainage outlets 150 symmetrically arranged on the top of the housing 110 with respect to the longitudinal axis of the body of the pool cleaning robot. Further, drainage outlets (not illustrated) can be symmetrically arranged on the front side of the housing 110 of the pool cleaning robot 100. As an example, the pool cleaning robot 100 can use the water spraying unit as an auxiliary traveling unit, so that the pool cleaning robot can be propelled to travel on the water surface, in the water, on the bottom and/or the side wall of the pool by a thrust generated from a water jet from a water spraying nozzle of the water spraying unit. In this case, the water jet from the water spraying nozzle can be guided to one of the drainage outlets provided on the housing 110 of the pool cleaning robot 100, thereby generating the thrust in different directions.

Although FIGS. 1A-1B illustrate the overall appearance of the pool cleaning robot according to the embodiment of the present disclosure. It should be understood that this is only schematic and does not constitute any limitation on the principles of the present disclosure.

As an example, the pool cleaning robot according to the present disclosure can be used to clean a swimming pool. When the pool cleaning robot cleans the bottom of the pool, if the bottom environment is complex, it is difficult to determine the specific situation of obstacles encountered only by ultrasonic wave or other ranging sensors. For example, it is impossible to distinguish cliffs, pits or being stuck due to being suspended by the pool cleaning robot's down-looking sensor. Among them, stuck due to being suspended refers to that the pool cleaning robot encounters obstacles, causing the wheels or wheels accompanying the tracks to detach from the support surface and be in a suspended state; and in such a case, the pool cleaning robot is stuck on the obstacles and cannot travel, resulting in being stuck due to being suspended. if the pool cleaning robot encounters obstacles such as an underground lamp in the normal travel on the bottom of the pool, the ranging sensor receives no return signal. If the pool cleaning robot happens to be stuck on the underground lamp at the moment, the pool cleaning robot can't determine what kind of situation it encounters and fails to make correct countermeasures, which will affect the cleaning efficiency.

In view of the above, it needs to detect whether the pool cleaning robot is trapped due to being suspended, and extricate the pool cleaning robot if it is trapped due to being suspended.

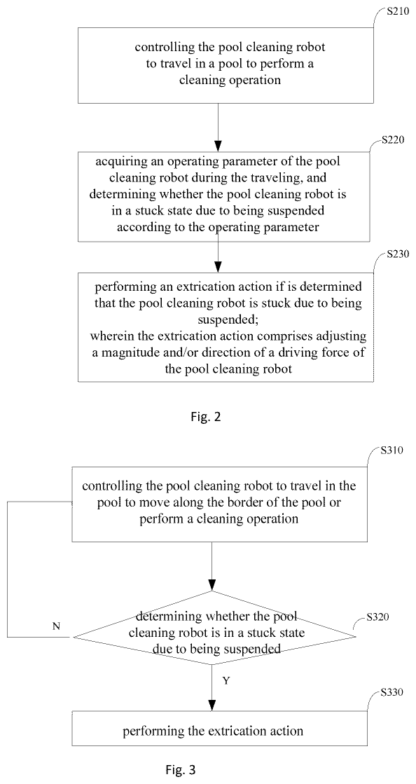

FIG. 2 schematically illustrates a method for extricating a pool cleaning robot from a stuck state according to an embodiment of the present disclosure, as illustrated in FIG. 2, which includes:
S210, controlling the pool cleaning robot to travel in the pool to perform the cleaning operation;
S220, in the traveling process, obtaining the operating parameter of the pool cleaning robot, and determining whether the pool cleaning robot is in a stuck state due to being suspended according to the operating parameter;
S230, if it is determined that the pool cleaning robot is in a stuck state due to being suspended, performing an extrication action;
wherein, the extrication action comprises adjusting a magnitude and/or direction of a driving force.

According to the above embodiments of the present disclosure, it can be detected the situation that the pool cleaning robot is stuck due to being suspended, and the corresponding ability to extricate the pool cleaning robot from a stuck state can be improved.

In an optional embodiment, the operating parameter can include at least one of the following: a time period of a straight travel of the pool cleaning robot, a distance of a straight travel of the pool cleaning robot, a current of a driving motor of the traveling mechanism, or the wheel speed of the traveling mechanism. If the pool cleaning robot is in a stuck state due to being suspended, the wheel is in a suspended state, and the load of the wheel will be changed compared to that in the normal traveling, and the current of the driving motor and the wheel speed will be changed compared to those in the normal traveling, for example, the current will be decreased and the wheel speed will be increased. Therefore, by monitoring the current of the driving motor of the pool cleaning robot and/or the wheel speed of the pool cleaning robot, it can be determined whether the pool cleaning robot is in a stuck state due to being suspended. In addition, since the wheel continues to rotate if it is suspended, the wheel speedometer can be used to continuously monitor the data regarding the traveling of the pool cleaning robot, although the pool cleaning robot does not travel actually in such a case. The travelling rules for the pool cleaning robot to perform the cleaning operation comprise making a turn if the pool cleaning robot encounters a wall of the pool, and then travelling straight, such as along the border of the pool, and making a turn again if encountering another wall. If the wheel speedometer monitors that the time period of a straight travel is too long or the distance of a straight travel is too long, it can be determined that the pool cleaning robot is stuck.

Therefore, in the present disclosure, it can be determined whether the preset condition is satisfied regarding at least one of the time period or distance of a straight travel of the pool cleaning robot, the current of the driving motor of the traveling mechanism or the wheel speed of the traveling mechanism, and if so, it is determined that the pool cleaning robot is in a stuck state due to being suspended. The preset condition includes: the time period of a straight travel being longer than a preset first time period, the distance of a straight travel being longer than a preset distance threshold, the current of the driving motor of the traveling mechanism being less than a preset current threshold, or the wheel speed of the traveling mechanism being greater than a preset wheel speed threshold.

Specifically, the straight travel follows the motion rules or paths of a cleaning operation, i.e, making a straight travel between making two turns, that is, a path from one side to another side of the pool. For example, the travel speed of pool cleaning robot in the swimming pool or pool is about 0.2 m/s, and the maximum length of the swimming pool or pool is generally no more than 20 m. Therefore, the preset first time period can be 100 s, and the preset distance threshold can be 20 m. If the wheel speedometer detects that the distance of the straight travel of the pool cleaning robot exceeds 20 m, or the continuous time period for the straight travel exceeds 100 s, it can be determined that the pool cleaning robot is stuck.

Specifically, determining whether the current of the driving motor of the traveling mechanism is less than a preset current threshold means determining whether all the current values within a preset second time period (for example, between 1 s and 5 s) are less than the preset current threshold, or whether the average value of the current value within the preset second time period is less than the preset current threshold, and if so, it means that the pool cleaning robot is stuck due to being suspended. Further, determining whether the wheel speed value of the traveling mechanism is less than the preset wheel speed threshold means determining whether all the wheel speed values in the preset third time period (for example, between 2 s and 6 s) are greater than the preset wheel speed threshold, or whether the average value of the wheel speed value in the preset third time period is greater than the preset wheel speed threshold, and if so, it means that the pool cleaning robot is stuck due to being suspended. It should be noted that the above-mentioned current value or wheel speed value is the value after excluding abnormal data. In particular, the preset wheel speed threshold is greater than 0.2 m/s.

In an optional embodiment, the driving force includes at least one of water thrust from the water spraying mechanism, thrust from the traveling mechanism and a buoyancy of the pool cleaning robot.

In an optional embodiment, the extrication action includes: adjusting the buoyancy of the pool cleaning robot, and extricating the pool cleaning robot from the stuck state by the buoyancy.

According to the above embodiment of the present disclosure, the pool cleaning robot moves upwards by the buoyancy to get out of the stuck state.

In an optional embodiment, performing the extrication action includes performing a first extrication action.

In an optional embodiment, if the pool cleaning robot is in a stuck state due to being suspended, performing the extrication action includes:
performing a first extrication action;
If the pool cleaning robot is still in the stuck state due to being suspended after performing the first extrication action for a preset first number of times, performing the second extrication action;
If the pool cleaning robot is still in the stuck state due to being suspended after performing the second extrication action for a preset second number of times, generating an alarm to inform the user to assist extricating the pool cleaning robot from the stuck state

According to the above embodiments of the present disclosure, the possibility of extricating the pool cleaning robot from the stuck state is increased by attempting different extrication actions for many times. If the pool cleaning robot cannot be extricated from the stuck state after the attempts, the alarm information can be generated and reported to the user so as to inform the user to assist the pool cleaning robot in getting out of the stuck state.

In an optional embodiment, the first extrication action includes:
adjusting a magnitude of water thrust from the water spraying mechanism; or
adjust the magnitude and/or direction of the thrust from the traveling mechanism.

According to the above embodiment, by increasing the water thrust from the water spraying mechanism, the thrust generated by the water spraying mechanism is increased, so as to extricate the pool cleaning robot from the stuck state; by increasing the thrust from the traveling mechanism such as the force applied to the wheel and controlling the pool cleaning robot to travel in different directions, the possibility of extricating the pool cleaning robot from the stuck state can be improved. The wheel referred to herein include a wheel or a driving wheel accompanying the tracks.

In an optional embodiment, the second extrication action includes:
adjusting the direction of the water thrust from water spraying mechanism;
adjusting the direction of the thrust from the traveling mechanism;
adjusting the magnitude and direction of the water thrust from the water spraying mechanism; or
adjusting the magnitude and direction of the thrust from the traveling mechanism.

According to the above embodiment of the present disclosure, the direction of water thrust from the water spraying mechanism can be changed so as to increase the possibility of extricating the pool cleaning robot from the stuck state; or, by increasing the magnitude of the water thrust from the water spraying mechanism and the magnitude of the thrust from the traveling mechanism, the traveling speed of the pool cleaning robot can be further increased and the possibility of getting out of the stuck state can be increased.

The present disclosure also provides a pool cleaning robot, which includes: a filter configured to filter the water entering the pool cleaning robot;
a traveling mechanism configured to drive the pool cleaning robot to travel on a supporting surface;
a water spraying mechanism configured to provide water thrust for the pool cleaning robot;
one or more processors; and
storage apparatus configured to store one or more programs;
when the one or more programs are executed by the one or more processors, the pool cleaning robot can perform the above extrication method.

FIG. 3 illustrates a method for extricating a pool cleaning robot from a stuck state, which comprises the following steps:
S310: controlling the pool cleaning robot to travel in the pool to move along the border of the pool or perform a cleaning operation.
S320: during the traveling process, determining whether the pool cleaning robot is in a stuck state due to being suspended, if so, performing the step S330; otherwise, controlling the pool cleaning robot to continue to move along the border or perform the cleaning operation.

Specifically, during the travelling, the operating parameter(s) of the pool cleaning robot is obtained, and then it is determined whether the pool cleaning robot is in a stuck state due to being suspended according to the operating parameter(s), that is, if the preset condition is satisfied regarding the operating parameter(s), it is determined that the pool cleaning robot is in the stuck state due to being suspended. For the detailed description of the operating parameter(s), please refer to the above and the details are not repeated herein.

At S330, the method comprises performing the extrication action. The extrication action includes adjusting the magnitude and/or direction of the driving force, the driving force including at least one of the water thrust from the water spraying mechanism, the thrust from the traveling mechanism and the buoyancy of the pool cleaning robot. Since the extrication action has already been described above, it will not be repeated herein.

Further, in some embodiments, the method further comprises controlling the pool cleaning robot to search for the sidewall of the pool or continue to perform the cleaning operation after the extrication operation is completed and successful.

Further, if the pool cleaning robot is still stuck after the above extrication actions are performed, it means that the pool cleaning robot cannot be extricated from the stuck state due to being suspended by itself, and an alarm message needs to be reported to the user via an application terminal to inform the user that the extrication failed and it needs the help from the user to extricate the pool cleaning robot from the stuck state.

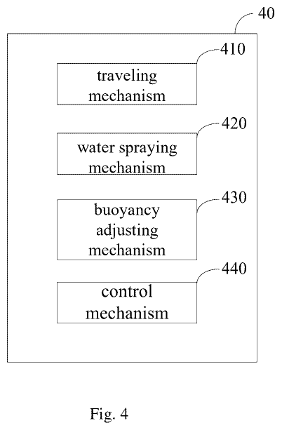

FIG. 4 illustrates a pool cleaning robot including:
a traveling mechanism 410 configured to drive the pool cleaning robot to travel on the pool bottom or the sidewall of the pool;
a water spraying mechanism 420 configured to provide water thrust for the pool cleaning robot; and
a control mechanism 440 configured to acquire the operating parameter(s) of the pool cleaning robot during the traveling process, and control the pool cleaning robot to perform an extrication action if the pool cleaning robot is in a stuck state due to being suspended.

As an example, the pool cleaning robot may further include a filter that filters the water entering the pool cleaning robot and discharges the filtered water into the pool.

As an example, the traveling mechanism 410 may include a wheeled traveling mechanism or a crawler traveling mechanism. For example, the traveling mechanism 410 may include a driving motor(s) that drives the wheels of the wheeled traveling mechanism to travel and/or a driving motor(s) that drives the driving wheels of the crawler traveling mechanism.

As an example, adjusting the magnitude of the thrust from the traveling mechanism may include, but is not limited to, adjusting the driving current, driving torque, and/or driving power of the driving motor for driving the left and/or right wheels of the pool cleaning robot; adjusting the direction of the thrust from the traveling mechanism can include, but is not limited to, adjusting the wheel speed difference between the left and right wheels of the pool cleaning robot, so that the direction of the resultant force of the thrust generated by the traveling mechanism changes.

As an example, the water spraying mechanism 420 may include a water pump, water spraying nozzles and/or at least two drainage outlets arranged on the housing of the pool cleaning robot. For example, the water pump sucks water from the pool and ejects the filtered water to the pool through the corresponding water spraying nozzles, providing the water thrust for the pool cleaning robot. As an example, the water spraying nozzles may include vector water spraying nozzles that can change the water spraying direction; or the water ejected from the water spraying nozzle can be guided to the drainage outlets at different positions arranged on the housing of the pool cleaning robot and discharged from the pool cleaning robot to the pool.

As an example, adjusting the water thrust from the water spraying mechanism may include, but is not limited to, adjusting at least one of the output power of the water pump, the water flow rate and/or the water flow speed of the water spraying mechanism; adjusting the direction of the water thrust from the water spraying mechanism may include, but is not limited to, adjusting the water spraying direction of the water spraying nozzle of the water spraying mechanism, such as rotating the water spraying nozzle; guiding the water flow ejected from the water spraying nozzle of the water spraying mechanism to the drainage outlets arranged at different positions on the housing of the pool cleaning robot; changing the rotating direction of the propeller blades of the water spraying mechanism; or a diversion pipe of the water spraying mechanism is rotated to switch the water spraying nozzles of the water spraying mechanism to the drainage outlets at different positions.

As an example, the pool cleaning robot may further include a buoyancy adjusting mechanism 430 configured to adjust the buoyancy of the pool cleaning robot in water; wherein, the buoyancy of the pool cleaning robot can be adjusted by the buoyancy adjusting mechanism, so that the pool cleaning robot moves upwards to get out of the stuck state.

As an example, the buoyancy adjusting mechanism 430 may include an air pump and an air storage chamber. For example, the buoyancy of the pool cleaning robot in the water can be adjusted by pumping the air into the air storage chamber by the air pump or discharging at least a part of the air in the air storage chamber.

As an example, the control mechanism 440 may include one or more processors and a storage apparatus for storing instructions, and when the one or more processors execute the instructions, the pool cleaning robot is caused to perform the above extrication method described in connection with FIGS. 2-3.

According to the above embodiments of the present disclosure, by the proposed method for extricating the pool cleaning robot from the stuck state due to being suspended and the corresponding pool cleaning robot, the stuck state of the pool cleaning robot can be efficiently detected, and the corresponding ability of the pool cleaning robot to get out of the stuck state can be improved.

From the above description of the embodiments, it can be clearly understood by those skilled in the art that the present disclosure can be realized by software and necessary general hardware, and it can also be fully realized by hardware. According to the embodiments of the disclosure, the storage apparatus includes a computer-readable storage medium, such as a computer floppy disk, a Read-Only Memory (ROM), a Random Access Memory (RAM), FLASH memory, hard disk or optical disk, etc.

It is noted that in the above embodiments, several units and modules therein is divided according to functional logic, but it is not limited to the above division; in addition, the specific names of functional units/modules are only for the convenience of distinguishing from each other, and are not used to limit the protection scope of this disclosure. The combination or substitution of any technical features in the above embodiments is included in the patent protection scope of this disclosure.

The above is only the embodiment of the disclosure, which does not limit the patent scope of the disclosure in any way. Any equivalent transformation made based on the contents of the specification and accompanying drawings of the disclosure, are equally included in the patent protection scope of the disclosure.

What is claimed is:

1. A method for extricating a pool cleaning robot from a stuck state, comprising:
controlling the pool cleaning robot to travel in a pool to perform a cleaning operation;
acquiring an operating parameter of the pool cleaning robot during the traveling, and determining whether the pool cleaning robot is in a stuck state due to being suspended according to the operating parameter; and
performing an extrication action in response to determining that the pool cleaning robot is in the stuck state due to being suspended;
wherein the extrication action comprises at least one of adjusting a magnitude of a driving force of the pool cleaning robot or adjusting a direction of the driving force.

2. The method according to claim 1, wherein the operating parameter includes at least one of:
a time period of a straight travel of the pool cleaning robot, a distance of the straight travel, a current of a driving motor of a traveling mechanism of the pool cleaning robot, or a wheel speed of the traveling mechanism;
wherein it is determined that the pool cleaning robot is in the stuck state due to being suspended if a preset condition is satisfied regarding at least one of the time period of the straight travel, the distance of the straight travel, the current of the driving motor, or the wheel speed of the traveling mechanism.

3. The method according to claim 2, wherein the preset condition being satisfied regarding at least one of the time period of the straight travel, the distance of the straight travel, the current of the driving motor, or the wheel speed of the traveling mechanism comprises at least one of:
the time period of the straight travel being longer than a preset first time period;
the distance of the straight travel being greater than a preset distance threshold;
the current of the driving motor being less than a preset current threshold; or
the wheel speed of the traveling mechanism being greater than a preset wheel speed threshold.

4. The method according to claim 3, wherein, the straight travel comprises traveling straight between making two turns; the current of the driving motor being less than the preset current threshold comprises the current being less than the preset current threshold within a preset second time period; and the wheel speed of the traveling mechanism being greater than the preset wheel speed threshold comprises the wheel speed being greater than the preset wheel speed threshold within a preset third time period.

5. The method according to claim 1, wherein the driving force comprises at least one of water thrust from a water spraying mechanism of the pool cleaning robot, thrust from a traveling mechanism of the pool cleaning robot, or buoyancy of the pool cleaning robot.

6. The method according to claim 5, wherein the extrication action comprises: adjusting the buoyancy of the pool cleaning robot so that the pool cleaning robot moves upwards to get out of the stuck state.

7. The method according to claim 5, wherein performing the extrication action comprises performing a first extrication action.

8. The method according to claim 7, further comprising: if the first extrication action fails to extricate the pool cleaning robot from the stuck state, performing a second extrication action.

9. The method according to claim 7, wherein the first extrication action comprises at least one of adjusting a magnitude of the water thrust from the water spraying mechanism or adjusting a magnitude of the thrust from the traveling mechanism.

10. The method according to claim 8, wherein the second extrication action comprises at least one of:
adjusting a direction of the water thrust from the water spraying mechanism;
adjusting a direction of the thrust from the traveling mechanism;
adjusting a magnitude and direction of the water thrust; or
adjusting a magnitude and direction of the thrust from the traveling mechanism.

11. A pool cleaning robot comprising:
a traveling mechanism configured to drive the pool cleaning robot to travel on a bottom or sidewall of the pool;
a water spraying mechanism configured to provide water thrust to the pool cleaning robot; and
a control mechanism configured to acquire an operating parameter of the pool cleaning robot during the traveling, determine whether the pool cleaning robot is in a stuck state due to being suspended according to the operating parameter and control the pool cleaning robot to perform an extrication action in response to determining that the pool cleaning robot is in the stuck state due to being suspended, wherein the extrication action comprises at least one of adjusting a magnitude of a driving force of the pool cleaning robot or adjusting a direction of the driving force.

12. The pool cleaning robot according to claim 11, wherein the operation parameter comprises at least one of:
a time period of a straight travel of the pool cleaning robot, a distance of the straight travel, a current of a driving motor of the traveling mechanism, or a wheel speed of the traveling mechanism;
wherein the control mechanism is further configured to determine the pool cleaning robot is in the stuck state due to being suspended based on a preset condition being satisfied regarding at least one of the time period of the straight travel, the distance of the straight travel, the current of the driving motor, or the wheel speed of the traveling mechanism.

13. The pool cleaning robot according to claim 12, wherein the preset condition being satisfied regarding at least one of the time period of the straight travel, the distance of the straight travel, the current of the driving motor, or the wheel speed of the traveling mechanism comprises at least one of:
the time period of the straight travel being longer than a preset first time period;
the distance of the straight travel being greater than a preset distance threshold;
the current of the driving motor being less than a preset current threshold; or
the wheel speed of the traveling mechanism being greater than a preset wheel speed threshold.

14. The pool cleaning robot according to claim 13, wherein, the straight travel comprises traveling straight between making two turns; the current of the driving motor being less than the preset current threshold comprises the current being less than the preset current threshold within a preset second time period; and the wheel speed of the traveling mechanism being greater than a preset wheel speed threshold comprises the wheel speed being greater than the preset wheel speed threshold within a preset third time period.

15. The pool cleaning robot according to claim 11, wherein the driving force comprises at least one of water thrust from the water spraying mechanism, thrust from the traveling mechanism, or buoyancy of the pool cleaning robot.

16. The pool cleaning robot according to claim 15, further comprising:
a buoyancy adjusting mechanism configured to adjust the buoyancy of the pool cleaning robot, so that the pool cleaning robot moves upwards to get out of the stuck state.

17. The pool cleaning robot according to claim 15, wherein the performing the extrication action comprises performing a first extrication action.

18. The pool cleaning robot according to claim 17, further comprising: if the first extrication action fails to extricate the pool cleaning robot from the stuck state, performing a second extrication action.

19. The pool cleaning robot according to claim 17, wherein the first extrication action comprises at least one of:
adjusting a magnitude of the water thrust from the water spraying mechanism; or
adjusting a magnitude of the thrust from the traveling mechanism.

20. The pool cleaning robot according to claim 18, wherein the second extrication action comprises at least one of:
adjusting a direction of the water thrust from the water spraying mechanism;
adjusting a direction of the thrust from the traveling mechanism;
adjusting a magnitude and direction of the water thrust; or
adjusting a magnitude and direction of the thrust from the traveling mechanism.
